(19) United States
(12) Patent Application Publication
(10) Pub. No.: US 2014/0291265 A1
(43) Pub. Date: Oct. 2, 2014

(54) High and Multi-Layer Warehousing and Planting-Cultivating Rotary Machine

(71) Applicant: SHREN-CHU OU, Taichung City (TW)

(72) Inventor: SHREN-CHU OU, Taichung City (TW)

(21) Appl. No.: 14/177,577

(22) Filed: Feb. 11, 2014

(30) Foreign Application Priority Data
Mar. 29, 2013 (CN) 201320151854.0

(51) Int. Cl. A47B 49/00; B65G 1/127; A47F 5/03

(52) U.S. Cl. CPC A47B 49/002; A47F 5/03; B65G 1/127
USPC 211/121

(57) ABSTRACT

A high and multi-layer warehousing and planting-cultivating rotary machine has a multiplicity of stands distributed, and partitioned in multi-layer, and a chain that winds in series, drives the multi-layer stands and is installed in a chain wheel that rotates with respect to a shaft which is mounted to a supporting body, where the stands is pivotally connected to the chain. The chain is distributed in pair on both sides of the stands to be wound and engaged the corresponding upper and lower chain wheels The chain is connected to a pin that is furnished in the pin hole provided at both ends of the stands and a bearing is also provided for the pin. The rotary machine is capable of achieving the alternate adjustment of the altitude of the stands in appropriate position by employing the chain to pull the multi-layer stands in series without having the user climbing up of employing a crane elevate up-and-down to access the goods stored in the stands.

### BACKGROUND OF THE INVENTION

1. Field of the Invention

The invention relates to a high and multi-layer warehousing and planting-cultivating rotary machine, and more particularly, to a high and multi-layer warehousing and planting-cultivating rotary machine that is simple in structure, easy to make, convenient to access and use, applicable to be used in industry, agriculture, and daily life.

2. Description of the Prior Art

The currently used warehousing facilities can only provide storage in the form of fixed pattern due to the structural defect giving the users a lot of inconvenience especially at the relatively higher storage positions which need climbing up or employing a crane to access the stored goods for the users making the existing conditions of security worries and low working efficiency. In addition, the applicable area of the currently used warehousing facilities is relatively singular making it not flexible in serviceability to fulfill efficacy that results in wasting resources.

Therefore, just how to resolve the above-mentioned problems has become an urgent issue to seek for an improving program in the industry.

### SUMMARY OF THE INVENTION

In light of the above-mentioned disadvantages of the prior art, the invention provides a high and multi-layer warehousing and planting-cultivating rotary machine that is capable of overcoming the shortcomings of the prior art, satisfying the requirements of the industry, as well as improving the competitiveness in the market. It aims to ameliorate at least some of the disadvantages of the prior art or to provide a useful alternative.

The objective of the invention is to provide a high and multi-layer warehousing and planting-cultivating rotary machine that is simple in structure, easy to make, convenient to access and use, applicable to be used in industry, agriculture, and daily life.

To achieve the above-mentioned objective, the invention provides a high and multi-layer warehousing and planting-cultivating rotary machine that has a multiplicity of stands distributed and partitioned in multi-layer, and a chain that winds in series, drives the multi-layer stands and is installed in a chain wheel that rotates with respect to a shaft which is mounted to a supporting body, where the stands is pivotally connected to the chain. The chain is distributed in pair on both sides of the stands to be wound and engaged the corresponding upper and lower chain wheels The chain is connected to a pin that is furnished in the pin hole provided at both ends of the stands and a bearing is also provided for the pin. The rotary machine is capable of achieving the alternate adjustment of the altitude of the stands in appropriate position by employing the chain to pull the multi-layer stands in series without having the user climbing up of employing a crane elevate up-and-down to take the goods contained in the stands.

in accordance with the above-mentioned structure, the chain is distributed in pair on both sides of the stands to be wound and engaged the corresponding upper and lower chain wheels and is connected to a pin that is furnished in the pin hole provided at both ends of the stands.

In accordance with the above-mentioned structure, a bearing is also provided for the pin.

In accordance with the above-mentioned structure, the supporting body can be either a wall or a column depending on the actual installation situation and space available.

In accordance with the above-mentioned structure, the rotary machine is a manually operated type or an electrically operated type.

The rotary machine is capable of achieving the alternate adjustment of the altitude of the stands in appropriate position by employing the chain to pull the multi-layer stands in series without having the user climbing up of having a crane elevate up-and-down to access the goods contained up the stands. Therefore, the warehousing rotary machine of the invention is capable of fully utilizing the space in different elevation to access the goods to economize the cost and in the mean time conveniently and safely operate to improve the efficiency. In actual application, the high and multi-layer warehousing and planting-cultivating rotary machine of the invention can be used in a manufacturing plant for conveyer assembly, or in department store, supermarket, exhibition, and the planting and cultivation in the field of agriculture, fishery, and livestock farming.

The accomplishment of this and other objectives of the invention will become apparent from the following description and its accompanying drawings of which:

### BRIEF DESCRIPTION OF THE DRAWINGS

FIG. 1 is a front view of the preferred embodiment of the manual-type of the high and multi-layer warehousing and planting-cultivating rotary machine of the invention.

2 is a schematic side view of the preferred embodiment of high and multi-layer warehousing and planting-cultivating rotary machine of FIG. 1 of the invention.

FIG. 3 is a front view of the preferred embodiment of the electrical-type of the high and multi-layer warehousing and planting-cultivating rotary machine of the invention.

### DETAILED DESCRIPTION OF THE PREFERRED EMBODIMENT

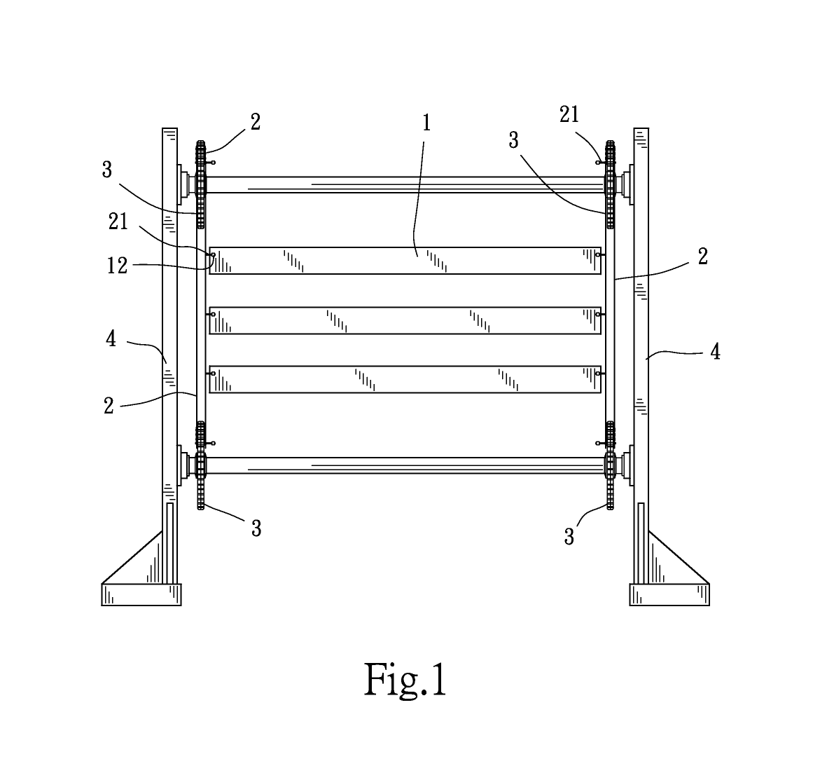

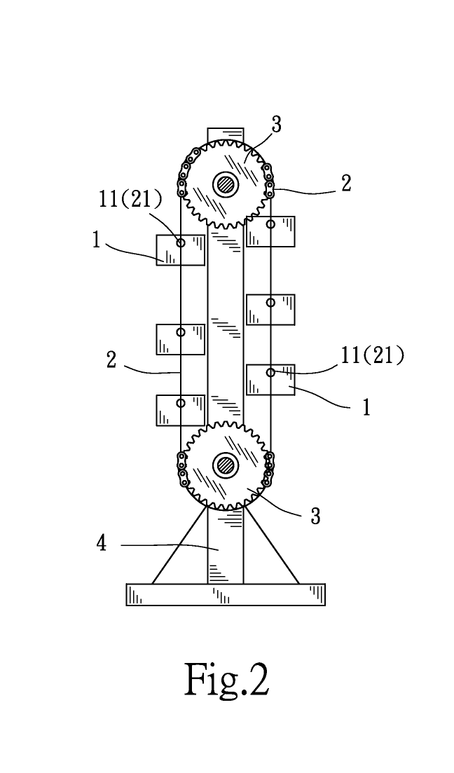

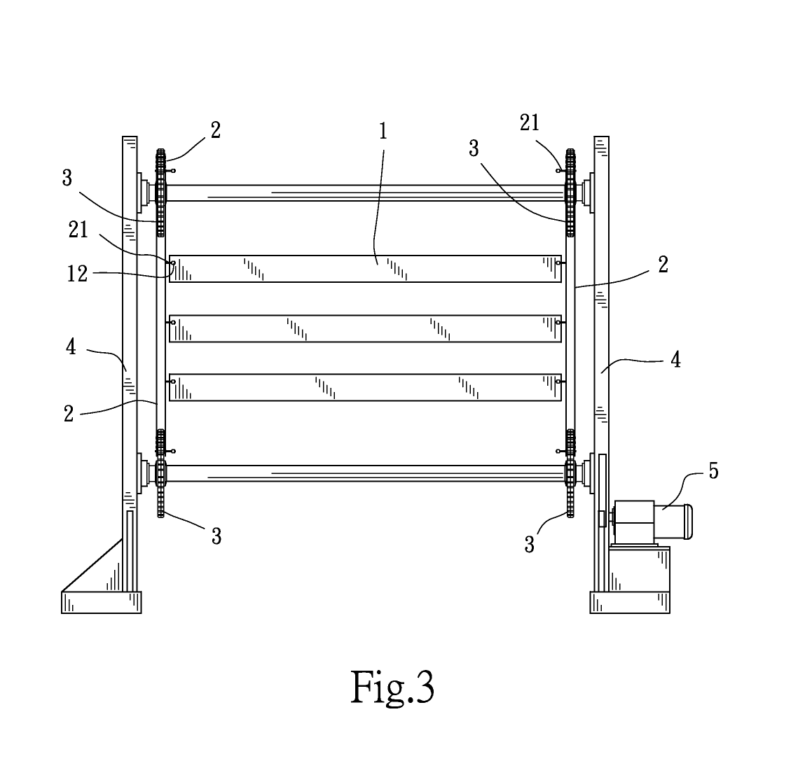

FIG. 1 is a front view of the preferred embodiment of the manual-type of the high and multi-layer warehousing and planting-cultivating rotary machine of the invention; FIG. 2 is a schematic side view of the preferred embodiment of high and multi-layer warehousing and planting-cultivating rotary machine of FIG. 1 of the invention; while FIG. 3 is a front view of the preferred embodiment of the electrical-type of the high and multi-layer warehousing and planting-cultivating rotary machine of the invention. As shown in FIG. 1, FIG. 2, and FIG. 3, the high and multi-layer warehousing and planting-cultivating rotary machine of the invention has a multiplicity of stands (1) distributed and partitioned in multi-layer, and a chain (2) that winds in series, drives the multi-layer stands (1) and is installed in a chain wheel (3) that rotates with respect to a shaft which is mounted to a supporting body (4). The stands (1) are pivotally connected to the chain (2). In this way, the rotary machine is capable of achieving the alternate adjustment of the altitude of the stands (1) in appropriate position by employing the chain (2) to pull the multi-layer stands in series without having a person climbing up of having a crane elevate up-and-down to take the object contained up the stands (1). Therefore, the warehousing rotary machine of the invention is capable of fully utilizing the space in different elevation to store or take object to economize the cost and in the mean time conveniently and safely operate to improve the efficiency.

As shown in FIG. 1 and FIG. 2, the manually operated high and multi-layer warehousing and planting-cultivating rotary machine of the invention is capable of fulfilling the rotation of the stands (1) wherein the chain (2) is distributed in pair on both sides of the stands (1) to be wound and engaged the corresponding upper and lower chain wheels (3). The chain (2) is connected to a pin (21) that is furnished in the pin hole (11) provided at both ends of the stands (1). A bearing (12) is provided for the pin (21) to facilitate the relative rotary action between the pin (21) and the stand (1) for diminishing rotary friction or interference and extending the service life. What is more, the assembly between the stands (1) and pin (21) is capable of facilitating the convenience of adjusting the partitioning position between the different stands (1) to achieve the flexibility of making the most of the space to accommodate practical application and improve the service performance.

As shown in FIG. 1, FIG. 2, and FIG. 3, the supporting body (4) can be either a wall or a column depending on the actual installation situation and space available. If it is a column, the supporting body (4) can be designed as removable type that is elevatory. In this case, the column can be built in accordance with the altitude requirements. The stands (1) can be types of a tray, a rack, or a pole to satisfy various service conditions depending on actual requirements. For examples, the tray type can be used for planting or cultivating while the rack type or pole type can be used for hanging various goods.

As shown in FIG. 3, the electrically operated high and multi-layer warehousing and planting-cultivating rotary machine of the invention needs a motor (5) to drive the chain wheel (3) to rotate by employing the engagement between the chain wheel (3) and the chain (2) to achieve the service efficacy of alternately adjust the altitude of the stands (1) to an appropriate position. In, this case, the electrically operated warehousing rotary machine of the invention can accommodate the computer oriented automatic control to acquire automation in timing and positioning the stands (1) to move to an appropriate service position.

In conclusion, the rotary machine is capable of achieving the alternate adjustment of the altitude of the stands (1) in appropriate position by employing the chain (2) to pull the multi-layer stands in series without having a person climbing up of having a crane elevate up-and-down to take the goods contained up the stands (1). Therefore, the warehousing rotary machine of the invention is capable of fully utilizing the space in different elevation to store or take goods to economize the cost and in the mean time conveniently and safely operate to improve the efficiency. In actual application, the high and multi-layer warehousing and planting-cultivating rotary machine of the invention can be used in a manufacturing plant for conveyer assembly, or in department store, supermarket, exhibition, and the planting and cultivation in the field of agriculture, fishery, and livestock farming.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A high and multi-layer warehousing and planting-cultivating rotary machine, having a multiplicity of stands (1) distributed and partitioned in multi-layer, and a chain (2) that winds in series, drives the multi-layer stands (1) and is installed in a chain wheel (3) that rotates with respect to a shaft which is mounted to a supporting body (4), where the stands (1) is pivotally connected to the chain (2).

2. The high and multi-layer warehousing and planting-cultivating rotary machine as claimed in claim 1, wherein the chain (2) is distributed in pair on both sides of the stands (1) to be wound and engaged the corresponding upper and lower chain wheels (3) and is connected to a pin (21) that is furnished in the pin hole (11) provided at both ends of the stands (1).

3. The high and multi-layer warehousing and planting-cultivating rotary machine as claimed in claim 2, wherein a bearing (12) is also provided for the pin (21).

4. The high and multi-layer warehousing and planting-cultivating rotary machine as claimed in claim 2, wherein the supporting body (4) can be either a wall or a column depending on the actual installation situation and space available.

5. The high and multi-layer warehousing and planting-cultivating rotary machine as claimed in claim 2, wherein the rotary machine is a manually operated type or an electrically operated type.
